(19) United States
(12) Patent Application Publication
(10) Pub. No.: US 2005/0240895 A1
(43) Pub. Date: Oct. 27, 2005

(54) Method of emulation of lithographic projection tools

(76) Inventors: Adlai H. Smith, Escondido, CA (US); Robert O. Hunter JR., Snowmass Village, CO (US); Joseph Bendik, Escondido, CA (US)

Correspondence Address: DAVID A. HALL;HELLER EHRMAN LLP, 4350 LA JOLLA VILLAGE DRIVE #700, 7TH FLOOR, SAN DIEGO, CA, 92122, US

(21) Appl. No.: 11/111,302

(22) Filed: Apr. 20, 2005

Related U.S. Application Data
(60) Provisional application No. 60/564,094, filed on Apr. 20, 2004.

(51) Int. Cl. G06F 17/50; G06G 7/62

(52) U.S. Cl. 716/19; 716/21; 703/13; 703/23

(57) ABSTRACT

Techniques for producing emulations of lithographic tools and processes using virtual wafers and lithographic libraries are described. Emulating a lithographic projection imaging machine includes determining characteristics of the imaging machine, of a reticle used in the imaging machine, and of layer specific processes. Then performing emulation on a virtual wafer using the characteristics of the imaging machine, reticle, and layer specific processes. The machine characteristics determined include characteristics of an exposure source, lens aberration, exit pupil, mechanics, vibration, calibration offsets, or resist. The reticle characteristics determined include distortion, critical dimension, phase transmission error, mask clips, as drawn specifications, or mask sites. And, the layer specific process characteristics include machine model, machine setting identification, and field exposure sequencing. Emulation results can be entered into an optimizer and optimum operating conditions related to the projection imaging machine are determined.

### REFERENCE TO PRIORITY DOCUMENT

This application claims the benefit of priority of U.S. Provisional Patent Application Ser. No. 60/564,094, entitled “Method of Emulation of Lithographic Projection Tools”, by Smith et al., filed Apr. 20, 2004. Priority of the filing date of Apr. 20, 2004 is hereby claimed, and the disclosure of U.S. Provisional Patent Application Ser. No. 60/564,094 is hereby incorporated by reference in its entirety.

### BACKGROUND OF THE INVENTION

1. Field of the Invention

The present invention relates generally to processes for semiconductor manufacturing and more particularly to characterizing lithographic projection systems.

2. Background

As semiconductor manufacturers race to produce integrated circuits with greater functionality and higher speed (smaller pitch, low k1, etc.,) in shorter periods of time, methods for improving process yields become more difficult and represent a gating factor for profitability. A critical, yet difficult and expensive, semiconductor process is lithography where process engineers and equipment manufacturers together are expected to produce high yields in the presence of fundamental physical limitations related to such features as resolution, depth of focus, and overlay control.

As the semiconductor industry pushes toward the fundamental limits of optical lithography, improvement in lithographic manufacturability, especially those related to advanced process control, lithographic simulation, and tool characterization/correction are necessary. While advances have been made in both theoretical and applied Advanced Process Control (APC) techniques for lithographic manufacturing semiconductor manufacturers, especially large foundries, have been extremely slow accepting, implementing, and transferring technology. Reasons for rejection include complexity, proof of return on investment (ROI), compatibility, and poor algorithm performance linked to process variability and incomplete tool characterization (see Tan et al., “Advanced Process Control for Semiconductor Manufacturing”, U.S. Pat. No. 6,263,255, Jul. 17, 2001).

Advances in lithographic simulation, notably speed and complexity, have become vital as the industry depends heavily on virtual process development and lithographic process optimization. Hereto however, the outputs and benefits of lithographic simulation, namely process optimization, depend strongly on the accuracy of the lithographic inputs, such as, source characterization, lens aberrations, resist modeling parameters, etc., and a good understanding of tool (machine) and process variability (see C. Hwang et al., “Impact of Illumination Intensity Profile on Lithography Simulation”, Optical Microlithography XVII, Proc. SPIE, Vol. 5377-149, 2004, pp. 1427-1434 and J. Cain et al., “Optimum Sampling for Characterization of Systematic Variation in Photolithography”, Optical Microlithography, Proc. SPIE, Vol. 4689-45).

Accurate methods for in-situ characterization of projection imaging systems, for example, quantifying lens aberrations and source non-uniformity, have only recently been accepted by industry (see A. Smith et al., “Apparatus, Method of Measurement and Method of Data Analysis for Correction of Optical System”, U.S. Pat. No. 5,828,455, Oct. 27, 1998, and B. McArthur et al., “In-Situ Source Metrology Instrument and Method of Use”, U.S. Pat. No. 6,356,345, Mar. 12, 2002). In these techniques, very high accuracy is needed because projection imaging systems are often pushed beyond performance specifications (sub-wavelength lithography) where lens aberrations and source non-uniformity degrade lithographic performance rather dramatically.

The ability to model, or simulate, the lithography process—especially the projection imaging system—has proved quite successful in improving manufacturing yields related to low k1 mask fabrication and lithographic processing. Improvements have been made by giving engineers the tools to optimize processes quickly and inexpensively. Electromagnetic (E&M) simulation and lithographic process modeling is discussed by Neureuther in several classic papers (see W. Oldham et al., “A General Simulator for VLSI Lithography and Etching Processes”, Part I Application to Projection Lithography IEEE Trans. Electron Devices, ED-26, No. 4, 1975, pp. 712-722, and M. Zuniga et al., “Reaction Diffusion Kinetics in Deep-UV Positive Tone Resist Systems”, Microlithography, Proc. SPIE, Vol. 2438, 1995, pp. 113-124). Today, the successful development of any low k1 lithography processes (circuit design, mask, and process development) requires the use of wave-front engineering techniques such as phase shift mask (PSM) and optical proximity correction (OPC) which depend heavily and almost exclusively on computation (see W. Grobman et al., “Reticle Enhancement Technology: Implications and Challenges for Physical Design”, DAC, Jun. 18-22, 2001, Las Vegas, Nev., p. 6).

In general, it should be noted that the performance of a lithographic simulator coupled with a stochastic engine is still rather limited—in the sense of being able to predict process performance—simply because the physical lithographic models require inputs (both statistical and absolute) that are typically unknown or estimated. See N. Jakatdar et al., “A Parameter Extraction Framework for DUV Lithography Simulation”, Metrology, Inspection, and Process Control for Microlithography XIII, Proc. SPIE, Vol. 3677, 1999, pp. 447-456. Lithographic simulation engines such as PROLITH™ or SOLID-C™ require up to approximately 100 modeling parameters, many of which are simply unknown, for the proper simulation of the lithography process.

The introduction of complex chemically amplified resist (CAR) has dramatically improved lithographic imaging. While CAR improves lithographic imaging it comes with the added cost of requiring many parameters to accurately model the resist performance, such as post exposure bake, non Fickian diffusion, etc., (see H. Yoshino, “Simulation of Chemically Amplified Resists”, Jpn. J. Appl. Phys., Vol. 31, 1992, pp. 4283-4287 and J. Byers et al., “Lumped Parameter Model for Chemically Amplified Resists”, Optical Microlithography XVII, Proc. SPIE 5377-152, 2004, pp. 1-13). Progress has been made in developing more accurate electromagnetic simulators and resist process models. However, the predictability of simulation is gated by the confidence level of the input parameters (see “A Parameter Extraction Framework for DUV Lithography Simulation”, supra). In general, the more detailed knowledge of the root causes of lithographic process variability and machine performance metrics (source uniformity, aberrations, synchronization error, focus, telecentricity to name a few) the better the simulation of the lithographic behavior and optimize process performance. Finally, advances in many other areas of semiconductor simulation have occurred in parallel to the development of lithographic simulators including: thermal processing, deposition, etch, and ion-implant to name a few (see Silvaco, “Process Simulation Paper General (Etch, Ion-Implant) Virtual Wafer Fab (Integrated TCAD Environment)”, www.silvaco.com/products/interactive_tools/vwf.html).

Methods for quantifying lithographic variability and its impact on circuit performance are discussed by several authors including Cain and Spanos (see “Optimum Sampling for Characterization of Systematic Variation in Photolithography”, supra). Statistical methods are often used in conjunction with lithographic simulation through stochastic algorithms that attempt to model the lithographic process virtually, where only limited process and machine data exists (see J. Wang et al., “A Novel Approach for Modeling and Diagnosing the Lithography Sequence”, AEC/APC, 2001).

Thus, there is a need for methods and apparatuses to improve the performance of lithographic simulators.

### SUMMARY

In accordance with embodiments of the invention, techniques are described for performance of lithographic simulators. Techniques for producing emulations of lithographic tools and processes using virtual wafers and lithographic libraries are described. In one embodiment, a method of emulating a lithographic projection imaging machine includes determining characteristics of the imaging machine, of a reticle used in the imaging machine, and of layer specific processes. Then, performing emulation on a virtual wafer using the characteristics of the imaging machine, reticle, and layer specific processes. Examples of the imaging machine characteristics determined include characteristics of an exposure source, lens aberration, exit pupil, mechanics, vibration, calibration offsets, or resist. Examples of reticle characteristics determined include distortion, critical dimension, phase transmission error, mask clips, as drawn specifications, or mask sites. And, examples of layer specific process characteristics include machine model, machine setting identification, and field exposure sequencing. The characteristics can be stored in a database.

The virtual wafer characteristics can include flatness profile information and a wafer identification number. Other examples of virtual wafer characteristics include wafer alignment marks, process layer identification, machine settings, and patterning results. The virtual wafer characteristics can be stored in a database. After an emulation has been performed, the virtual wafer database can be updated with results from the emulation.

The characteristics of imaging machine, reticle, and layer specific process can be updated periodically based upon, for example, fabrication statistics, throughput, cost considerations, advanced process control, or neural networks.

In another embodiment, a method of emulating a lithographic projection imaging machine includes characterizing an exposure source of the projection imaging machine. A lens aberration and exit pupil of the projection imaging machine are also characterized. In addition, the mechanics of the projection imaging machine are characterized, as well as the reticle used in the projection imaging machine and layer specific processes of the projection imaging machine. A virtual wafer is provided and a simulation is run on the virtual wafer using the characterizations. Then a virtual wafer database is updated with the results of the simulation.

Another embodiment includes a method for producing a photolithographic chip mask work from a lithographic projection machine and process. The method includes designing a lithographic design-of-experiment (DOE). Then, emulating the DOE by determining characteristics of the imaging machine, of a reticle used in the imaging machine, and of layer specific processes. An emulation is performed on a virtual wafer using the characteristics of the imaging machine, reticle, and layer specific processes.

A microelectronic chip production system can include a production system controller that is configured to accept characteristics of a lithographic projection system, of a reticle used in the lithographic projection system, and of layer specific processes. The controller may perform an emulation on a virtual wafer using the characteristics of the lithographic projection system, reticle, and layer specific processes. The system may also include a scanning controller that controls a scanner of the lithographic projection imaging system. And, a process controller that adjusts the operation of the scanner in accordance with the outputs generated by the lithographic virtual machine emulator and production system controller.

A method of controlling a lithographic projection imaging machine can include performing lithographic emulation. The emulation is performed by determining characteristics of the imaging machine, of a reticle used in the imaging machine, and of layer specific processes. A simulation is performed on a virtual wafer using the characteristics of the imaging machine, reticle, and layer specific processes. Then, the projection imaging system is adjusted in accordance with the results of the emulation. For example, the projection imaging system can be adjusted to minimize, process variation, yield loss, or machine error.

A lithographic virtual machine emulator may be tuned by emulating a lithographic machine and process using a lithography simulator. A set of fabrication measured lithographic data may be provided and compared to the emulated lithographic output. Then, adjusting simulation models and parameters in accordance with the comparison to minimize a difference between the emulation lithographic output and the measured lithographic data. The process of emulating, comparing and adjusting is repeated until a desired convergence between the emulation lithographic output and the measured lithographic data is achieved. Examples of lithographic data used in the comparison can include a critical dimension, a sidewall angle, resist loss, feature position, process windows, Bossung plots, DRM data, resist information, or resist stack cross section information.

In another embodiment, a cost-of-ownership analysis is performed. The analysis includes performing lithographic emulation of an imaging machine that includes determining characteristics of the imaging machine, of a reticle used in the imaging machine, and of layer specific processes. The lithographic emulation is performed for a desired number of machines. Then a cost-of-ownership is determined using analysis software.

The embodiments may be encoded onto a computer readable media as computer instructions. The computer instructions may be executed by a processor to complete the steps of the embodiments.

Examples of lithographic projection imaging machines that the techniques can be used with include a stepper, a one dimensional scanner, a two dimensional scanner, an EUV scanner, an EPL machine, or an image side immersion lens.

Emulation results can be entered into an optimizer. The optimizer may determine optimum operating conditions related to the projection imaging machine. Then, using the optimized operating conditions, a wafer may be exposed.

Example of wafers include a silicon wafer coated with resist, a resist coated flat panel, a resist coated circuit board, or electronic recording device. Examples of electronic recording devices include a CCD or CMOS device.

Other features and advantages of the present invention should be apparent from the following description of exemplary embodiments, which illustrate, by way of example, aspects of the invention.

### BRIEF DESCRIPTION OF THE DRAWINGS

FIG. 1 is a block diagram illustrating steps for performing Virtual Machine Emulation.

FIG. 2 is a block diagram illustrating a detailed description of a dynamic lithographic VME software framework executing in a computer.

FIG. 3 shows the transverse mechanical offset synthesizer module (TMOS).

FIG. 4 shows the Z-mechanical offset synthesizer (ZMOS), which can be used to generate wafer height and machine leveling performance behavior.

FIG. 5 is a flow chart illustrating a framework for automatic calibration of lithography simulators using a set of patterned and un-patterned characterization experiments.

FIG. 6 shows a reticle with locations of mask clips schematically and in detail shown.

FIG. 7 shows an AsDrawn specification (ADID) for a 1-D printed photoresist feature—where ADID=ISOLINE, with a 1-D array of critical parameters [critical dimension (CD), position (XC), and resist loss (RL)], and a sample of a complex mask descriptor (CMD) that details mask clip geometry, variations from ideal geometry, and the physical layout over the reticle for an isolated mask feature with MSKID=Isoline.

FIG. 8 shows a chip layout on a reticle and the relation to reticle alignment mark locations.

FIG. 9 shows virtual wafer processing steps for adding process dependent flatness using the VME.

FIG. 10 shows the process of the creation of realistic blank virtual wafers.

FIG. 11 shows the hierarchy for managing the machine parameter database including MA_LIB, MALibrarian.exe, MXT cross-reference table, and MAID structure.

FIG. 12 shows the MXT cross-reference table listing machine id (MAID), machine model (MMODEL), wafer diameters accepted (Dwaf), nominal operating wavelength (λ) and maximum x,y image field sizes (Fx, Fy).

FIG. 13 illustrates a hierarchical layout of a machine database for organized machine emulation over a range of machine operating conditions; directory structure for a machine database illustrating a range of machine operating conditions.

FIG. 14 shows an example of a reticle bundle file (RBF) as a virtual reticle (VR) representing a physical reticle identified by its reticle serial number and the specific process/layer it is to be used for.

FIG. 15 shows a chip layout specification (CLS) for a reticle bundle file.

FIG. 16 shows a sample reticle alignment mark table (RAMTBL) listing nominal and exact physical positional measurements for each wafer alignment mark (RAMID).

FIG. 17 shows hierarchy for the management of virtual reticle bundles using a virtual reticle library (VRLIB) and VRLibrarian.exe reference program for accessing the reticle cross-reference table (RXRT), allowing rapid selection of virtual reticles for machine emulation.

FIG. 18 shows a description of the reticle and process layer cross-reference table (RXRT).

FIG. 19 shows the hierarchy structure for management of process/layer specifications including library manager.

FIG. 20 shows a sample process/layer specification for a “trench” layer process for a DRAM circuit.

FIG. 21 shows the hierarchical layout of process and layer specifications for organized VME.

FIG. 22 shows an example of a process and layer data hierarchy for multiple processes, wherein machine models generally require separate specifications for the same process/layer combination because the machine setup identifiers differ from model to model.

FIG. 23 is a block diagram illustrating an alternate VME configuration integrated in to a general process simulator that includes a lithographic simulation engine configured as a virtual machine emulator.

FIG. 24 illustrates an AsDrawn specification (ADID) for an isolated line and corresponding CMD that details parametric variation in mask clip across a reticle.

FIG. 25 is a block diagram of an exemplary computer for executing emulation of a lithographic projection tool.

### DETAILED DESCRIPTION

Remarkable progress has been made on characterizing the lithographic projection imaging system through the combined use of simulation and novel metrology methods. Advances in metrology techniques have improved the characterization of components of lithographic systems. For example, methods for the characterization of lens aberrations can be found in Smith (see “Apparatus, Method of Measurement and Method of Data Analysis for Correction of Optical System”, supra and A. Smith et al., “Apparatus, Method of Measurement and Method of Data Analysis for Correction of Optical System”, U.S. Pat. No. 5,978,085, Nov. 2, 1999). Also, methods for the characterization of illumination sources can be found in Smith (see “In-Situ Source Metrology Instrument and Method of Use”, supra), and methods for the measurement of lens distortion for both steppers and scanners (in the presence of systematic and random synchronization error) can be found in Smith (see “Method and Apparatus for Self-Referenced Dynamic Step and Scan Intra-Field Lens Distortion”, U.S. patent application Ser. No. 10/252,020, Sep. 20, 2002, and A. Smith et al., “Method and Apparatus for Self-Referenced Projection Lens Distortion Mapping”, U.S. Pat. No. 6,573,986, Jun. 2, 2003). Techniques for the measurement of dynamic scanning synchronization error can be found in Smith (see “Method and Apparatus for Self-Referenced Dynamic Step and Scan Intra-Field Scanning Distortion”, U.S. patent application Ser. No. 10/252,021, Sep. 20, 2002). Mapping the transmission function and reticle-side telecentricity of a projection imaging system can be found in Smith (see “Apparatus and Method for Measurement of Exit Pupil Transmittance”, U.S. Provisional Patent Application No. 60/562,632, Apr. 14, 2004). Also, techniques for determining focus in the presence of wafer curvature and lens aberrations can be found in Smith (see “Apparatus and Process for Determination of Dynamic Lens Field Curvature”, U.S. patent application Ser. No. 10/833,557, Apr. 28, 2004, and “Apparatus and Process for Determination of Dynamic Scan Field Curvature”, U.S. patent application Ser. No. 10/833,781, Apr. 28, 2004).

The ability to accurately measure the performance of the projection imaging system has proved to be valuable for tool acceptance, production monitoring, simulation, and advanced process control applications (see P. DeBisschop, “Evaluation of Litel's In-Situ Interferometer (ISI) Technique for Measuring Projection Lens Aberrations: An Initial Study”, Optical Microlithography, Proc. SPIE, Vol. 5040, 2003, pp. 11-23).

There now is an opportunity to link the progress made in lithographic simulation, statistics, machine characterization, and advanced process control (APC) in such a way as to create a system (a virtual machine emulator) capable of emulating lithographic performance completely and accurately. Emulation, or the ability to mimic in software, hardware and/or processes in such a way so as to produce output nearly identical to the original source has been desired for many years. The ability to perform accurate lithographic emulation depends on the confidence level of the lithographic inputs—this requirement has limited the practicality of creating such a system because emulators are expected to perform reliably and continuously. Construction of an accurate lithographic emulator is valuable in the sense that critical risk/reward applications such as machine adjustment, machine specific product flow, lot disposition, lot rework, process development, and advanced process control applications become economically viable.

A method for producing emulations of lithographic tools and processes using virtual wafers and lithographic libraries is described. First, preferred methods for characterizing projection imaging tools, reticles, wafers, and lithographic processes are described including methods for the construction of lithographic libraries. Next, methods for creating and updating virtual wafers using lithographic simulation engines are described. The lithographic characterization methods, lithographic libraries, lithographic simulator, and virtual wafers are integrated into a dynamic software framework to form a lithographic virtual machine emulator (VME) capable of accurately predicting lithographic performance.

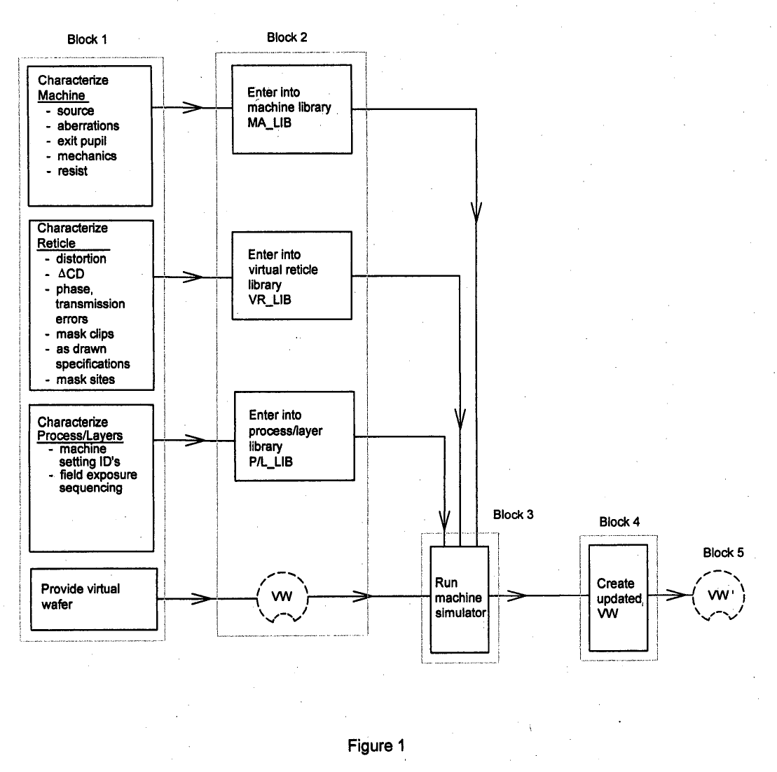

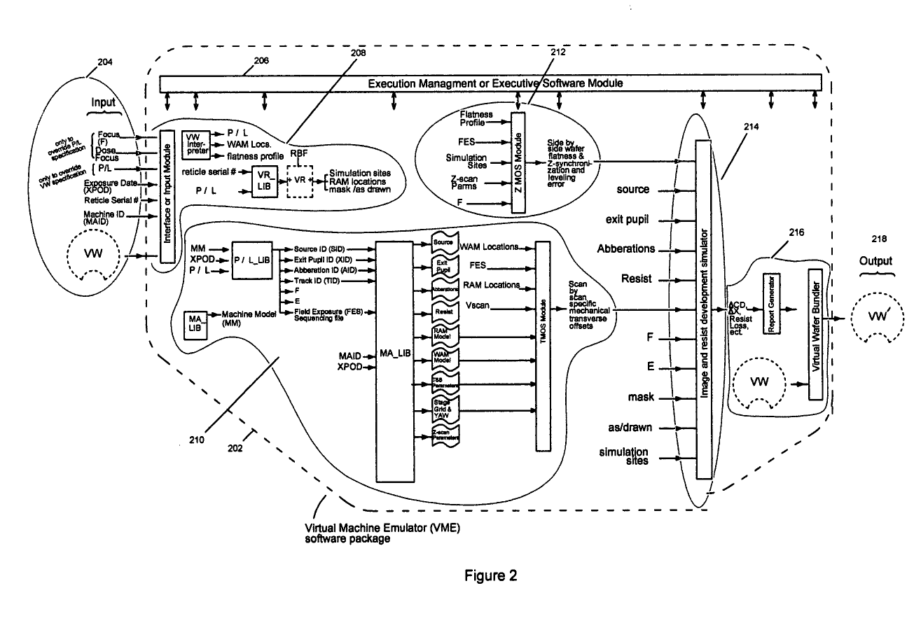

FIG. 1 illustrates a process for lithographic machine emulation consisting of five main blocks. “Machine” means a lithographic projection stepper or step and scan tool (scanner) possibly integrated to a lithography track. The present invention can be implemented in terms of a VME or Virtual Machine Emulator framework as shown in FIG. 2, discussed further below. It is important to note that the VME is a dynamic system which responds to inputs on a varying time scale determined by both the execution mode of the software (and possibly hardware) interfaces and machine and process characterization rates (Ĉmᵢ & Ĉpᵢ respectively). A characterization rate, Ĉxᵢ, represents how often the machine or process (variable x) is sampled to reflect changes in a particular machine or process performance metric (i).

Characterization rates are well known, and are generally set by fabrication maintenance procedures, and are typically on time scales that represent a balance between downtime and statistical optimization or that determined by an appropriate APC methodology. The characterization rates simply represent the fact that the emulation virtual libraries must be constantly updated to reflect changes in machine and process performance.

The lithographic emulation techniques described herein are very different compared with conventional lithographic simulation. For example, the emulation techniques can accurately reflect and respond (create virtual wafers) to machine and process fluctuations that occur during lithographic fabrication—while conventional simulation represents a fixed or static lithographic metric, even when implemented with statistical yield models. Looked at another way, emulation as described herein allows for the accurate (believable) recreation of machine and process performance continuously while conventional simulation mimics machine (and process) performance given correct and accurate input.

FIG. 1 is a block diagram describing a detailed overview of the emulation procedure. Then FIG. 2 provides a detailed description of a dynamic lithographic VME software framework whose output is of high enough accuracy that critical risk/reward operations (alternate embodiments of the present invention) such as: machine adjustment, machine specific product flow, lot disposition, lot rework, process development, and advanced process control become economically viable. Additional embodiments describe methods for quantifying metrology performance, extending the emulation simulation engine to include thermal processing, deposition, etch, and ion-implant and possible others, as well as methods of producing integrated circuits. The VME “software package” illustrated in FIG. 2 executes in a programmable digital computer.

FIG. 1 illustrates steps for performing Virtual Machine Emulation. As shown in FIG. 1, the steps are described using five blocks. Block 1 includes characterizing the lithographic machine and process. Then, in block 2 the characterization and process are entered into one or more libraries. In block 3 the lithography simulator is run using inputs from the libraries of block 2. Then in blocks 4 and 5 an updated virtual wafer is created and the VW is processed again. Following is a detailed description of each block in FIG. 1.

Block 1 of FIG. 1

Characterize Lithographic Machine, General

The optics and mechanics of the machine as they relate to image formation are characterized as described below for block 1 of FIG. 1. Again, machine characterization creates a strong distinction between machine emulation, the ability to faithfully recreate machine performance, and machine simulation, the ability to mimic machine performance given the correct inputs. The term machine characterization is used to mean the extraction of tool specific parameters—generally using preferred methods. In addition, use is made of identifiers (_ID) to categorize and identify machine specific information as it pertains to the overall VME (see FIG. 2) and its interaction with a virtual library. Finally, since emulation is a dynamic process, time stamps and data histories are used to update VME databases and libraries. The characterization of machine attributes in block 1 can be performed in any desired order.

Characterize Machine, Source

The source is characterized, for example the source or radiant intensity profile (dE/do (nx,ny)) and light color spectrum (e.g., laser line centers and line widths) as it is incident on the reticle may be measured. Directly characterizing the radiant intensity profile can utilize the method and apparatus of “In-Situ Source Metrology Instrument and Method of Use”, supra, to determine

$$\frac{ⅆ E}{ⅆ o}$$

at multiple transverse field points (xᵢ, yᵢ). For the VME, dE/do can be identified do by a source identifier (SID) representing the nominal identifier for machine programming. Thus, SID=‘standard 1’ means an operator programming the stepper would type in or select SID to get the illuminator to the desired condition (see FIG. 2 reference 210 for example). The characterization sampling time for the source measurement (see “In-Situ Source Metrology Instrument and Method of Use”, supra) is determined by consideration of fabrication, or “fab”, thru-put, fab statistics, APC methods as mentioned earlier. Additionally, a source polarization map, statistical history of the laser spectrum, background noise spectrum, and laser bandwidth including statistics—as recorded by the laser's internal data log or scanner metrology database—may be entered into the machine library database. Again, the information may be updated on a time scale as described above. In addition, flare data—as obtained by the methods specified in the work by Kanda and Shibuya (see T. Kanda et al., “0.85 NA ArF Exposure System and Performance”, Optical Microlithography, Proc. SPIE, Vol. 5040-5069, 2003, pp. 789-800 and M. Shibuya et al., “Random Aberration and Local Flare”, Optical Microlithography, Proc. SPIE, Vol. 5377, 2004, pp. 1910-1920) can also be included in the machine library database. Finally, information pertaining to source telecentricity may be entered into the machine library using the methods specified in see “In-Situ Source Metrology Instrument and Method of Use”, supra. The following additional information may also be entered into the machine library database: the source ID (SID), source measurement date, and the specific machine identifier (MAID)—see FIG. 2 reference 210—where the MAID is the working designation assigned to the physical machine of concern.
Characterize Machine, Aberrations

Lens aberrations are characterized. For example, the lens aberrations for the projection tool may be determined, or measured, and entered into the machine library. A method for measuring lens aberrations, specific to the projection imaging system, using an interferometer is described in “Apparatus, Method of Measurement and Method of Data Analysis for Correction of Optical System”, supra and “Apparatus, Method of Measurement and Method of Data Analysis for Correction of Optical System”, supra. Theses methods allow for the characterization of aberrations, Φ (nx, ny) at multiple points in the projection-imaging field using an in-situ reticle plate. Additionally, if laser spectrum parameters are provided, then the lens aberration response to wavelength shifts, bandwidth, spectrum shape (intensity), and polarization may also be provided. For example, the methods described in the co-pending patent application, A. Smith et al., “Process and Method for Measurement of Crossfield Chromatic Response of Projection Imaging Systems”, U.S. Provisional Patent Application No. 60/627,688, filed Nov. 12, 2004, can be used to provide the quantities listed above (i.e., dai/dlambda=change in Zemike coefficient number per unit wavelength). The Zernike expansions used in conjunction with laser spectrum parameters help characterize the system response with wavelength. Methods for determining low order aberrations (tilt terms) include “Method and Apparatus for Self-Referenced Dynamic Step and Scan Intra-Field Lens Distortion”, supra. Furthermore, if the wavelength shifts, bandwidth, spectrum shape (intensity), and polarization are measured at the wafer plane then a more complete analysis may be possible. Finally, methods for determining long range flare such as those described in “0.85 NA ArF Exposure System and Performance”, supra can also be included in the machine characterization because they can usually be accounted for with a high order Zemike expansion.

VME machine library input (see FIG. 2 reference 210): scanner machines (with a specific MAID) that have user specified projection lens adjustment settings are identified by a unique aberration identifier(s) (AID). Different AID settings arise in the need to match machines or create process/layer specific optimized aberrations. For machines without this adjustment ability, the VME machine library uses a default ID or AID=‘ZERO’.

In summary then, aberrations Φ, flare expansion, AID, MAID, and the ISI exposure data may be entered into the machine library (MA_LIB). Again, the time interval for characterization is determined by fab statistics, thru-put balances, APC methodologies, or changes in VME output (see below).

Characterize Machine, Exit Pupil

The exit pupil is characterized. For example, the exit pupil transmission function may be determined or measured and entered into the machine library (MA_LIB). A method for characterizing exit pupil transmission T(nx, ny) as a function of field position, is described in the reference “Apparatus and Method for Measurement of Exit Pupil Transmittance”, supra. The method is similar to that described in reference see “In-Situ Source Metrology Instrument and Method of Use”, supra where resist measurements are used for reconstructing the radiant intensity function. Following exit pupil characterization, the machine library database may be populated with the exposure date, MAID, and the exit pupil identifier (XID). Additional information such as polarization effects and reticle-side telecentricity (see “Apparatus and Method for Measurement of Exit Pupil Transmittance”, supra) may also be entered.

Characterize Machine, Mechanics

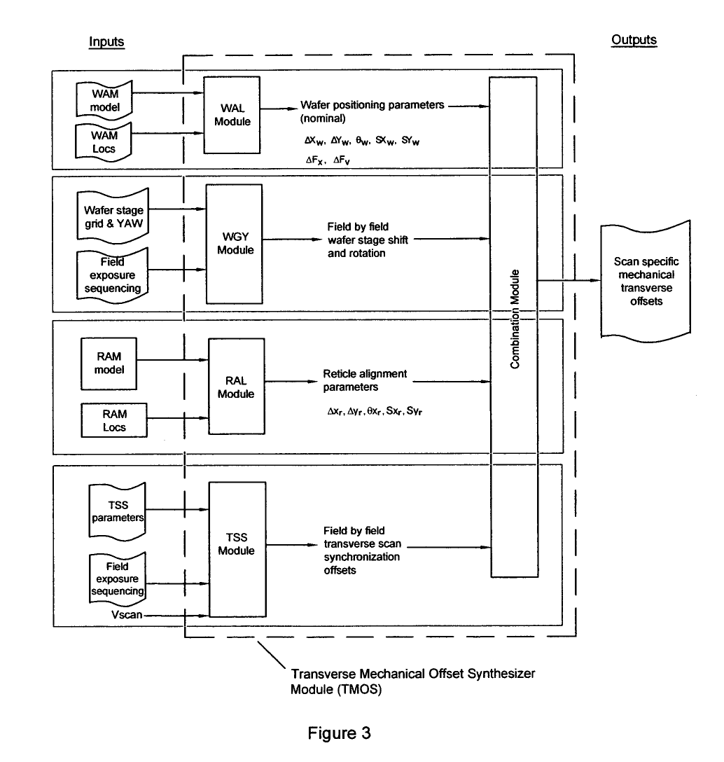

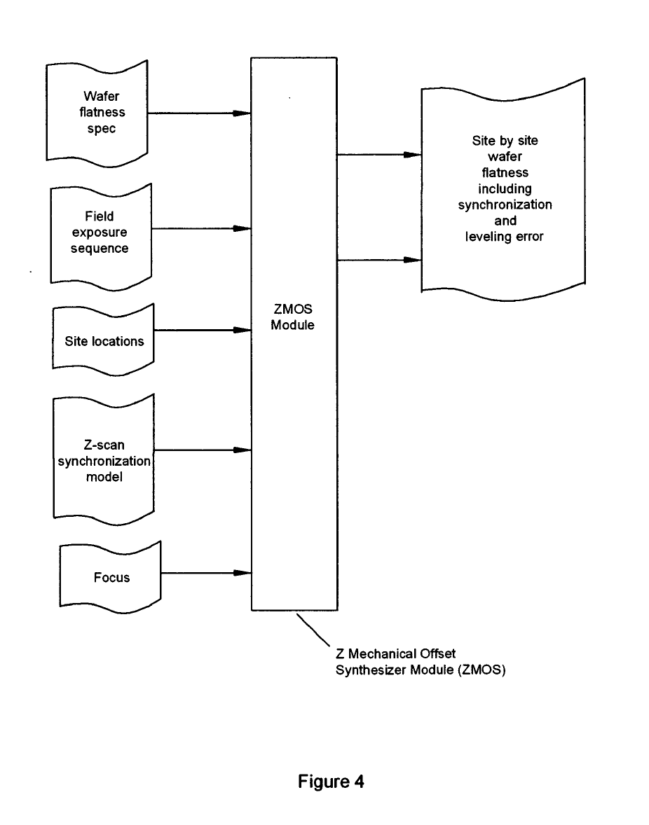

The machine mechanics may also be characterized. For example, machine mechanics may be determined or measured and entered into the VME machine library. A method for characterizing scanner machine mechanics can be found in “Method and Apparatus for Self-Referenced Dynamic Step and Scan Intra-Field Scanning Distortion”, supra, where transverse scanner synchronization (TSS) error is determined and separated from the effects of lens distortion. In addition, methods for determining MSD or dynamic vibration components with rms values near 0 using interferometers including stage velocity (Vscan in FIG. 2 reference 210) are described in reference see Performance of a step and scan system for DUV lithography; G. de Zwart, et. Al.; SPIE Vol. 3051; pp. 817:835—including calibration and metrology offsets that account for systematic scanning stage error. Methods for determining wafer stage and possibly reticle stage grid and yaw errors, for both steppers and scanners, such as those described in Smith (see “Method and Apparatus for Self-Referenced Projection Lens Distortion Mapping”, supra, and “Method and Apparatus for Self-Referenced Wafer Stage Positional Error Mapping”, U.S. Pat. No. 6,734,971, May 11, 2004) are useful for determining across wafer stage performance. Finally, methods for characterizing the z-mechanics, intra-field static and dynamic focal plane deviation, such as those described in “Apparatus and Process for Determination of Dynamic Lens Field Curvature”, supra and “Apparatus and Process for Determination of Dynamic Scan Field Curvature”, supra are also important (see FIG. 2 references 202 and 212). Once determined, the entire set, or a portion of the set, of characterization and metrology data may be entered into the virtual machine library database (see MA_LIB in FIG. 1 block 2) along with time stamps (metrology dates). During VME operation the machine mechanical data is extracted from the machine library by a transverse mechanical offset module (TMOS see FIG. 3) and a Z-mechanical offset synthesizer (ZMOS see FIG. 4). The TMOS module provides scan-by-scan transverse mechanical offsets for input into the lithography simulator. The ZMOS module provides side-by-side wafer flatness and Z-synchronization/leveling for input into the lithography simulator. For static emulation (VME for steppers) many of the above characterization procedures are not required.

Characterize Machine, Resist

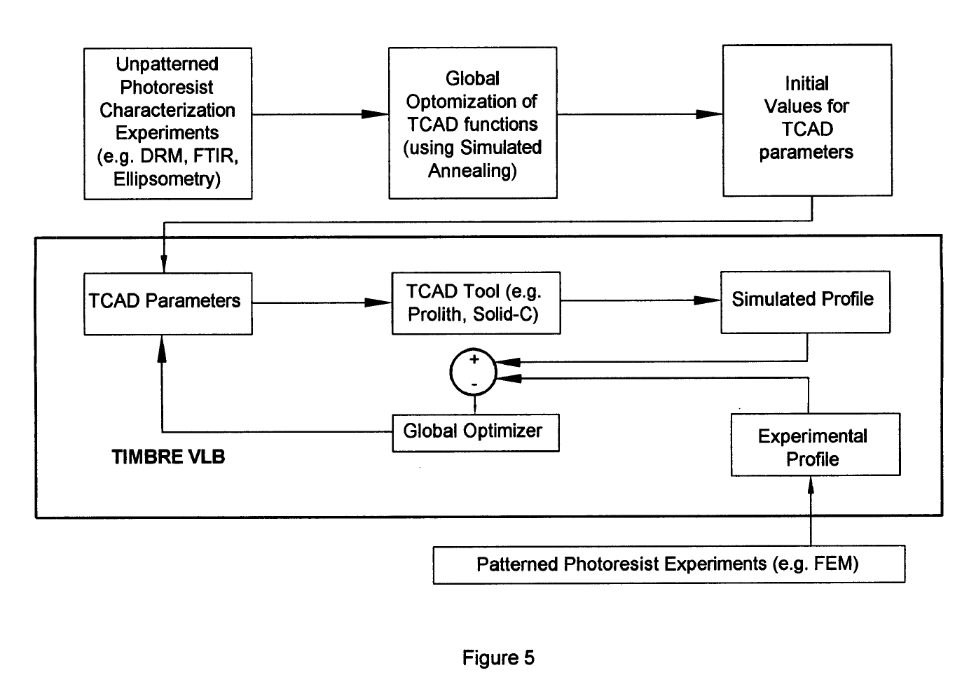

The resist/process may be characterized. For example, methods for characterizing the resist process typically include; measuring the optical properties of the complete thin-film stack, for example, thk., n, k for each layer, (see wwwjawoollam.com, J. Woollam Company) using reflectance or ellipsometry, exposure parameters (A, B, C or Dill parameters for i-line resists) using transmission tools, specifying resist chemistry (CAR or i-line), measuring or modeling the kinetic behavior (reaction and diffusion) using FTIR or other methods (see “Reaction Diffusion Kinetics in Deep-UV Positive Tone Resist Systems”, supra), determining the bake profiles (temperatures of the bake process including plate profiles) using bake plate temperature sensors, determining parameters uniquely associated with a particular resist development model using DRM, Eo, and swing curve data, and a good understanding of the metrology that is needed to measure or estimate the resist profile (SWA, Resist Loss, and CD (see “Top Down Versus Cross Sectional SEM Metrology and its Impact on Lithography Simulation Calibration”, supra)). In general, modeling resists and resist processes is extremely complicated—even for simplest of resist systems and processes—which explains why simple process models are often used (see “Approximate Models for Resist Processing Effects”, supra). A preferred and tractable method for constructing a proper set of resist parameters that characterizes the resist and resist process is described in Jakadar et. Al (see “A Parameter Extraction Framework for DUV Lithography Simulation”, supra). These methods are useful because they make use of both experimental and estimated parametric data. In addition, the framework supports a variety of empirical models and simulation engines (see C. Mack “A Comprehensive Guide to Optical Lithography Simulation”, Finle Technologies, ISBN 0-9650922-O-8, 1997, and “Approximate models for Resist Processing Effects”, supra). The overall framework is described in FIG. 5 below and the integration of the framework to the VME is shown in FIG. 2 reference 214. Once a resist is characterized the data is entered into the machine library.

Characterize Reticle, General

The reticle used in the machine as it relates to image formation are characterized as described below for block 1 of FIG. 1. Again, reticle characterization creates a strong distinction between machine emulation, the ability to faithfully recreate machine performance, and machine simulation, the ability to mimic machine performance given the correct inputs.

Characterize Reticle, Distortion

Reticle distortion or deviation of the position of features on the reticle from their ideal position is inherent in the reticle manufacturing process. While maximum distortions in the 50-100 nanometer range are typically achieved, it can still represent a sizeable portion of the total overlay budget. This distortion can be accurately measured at the <10 nm level by optical metrology tools (see Actual Performance Data Obtained on New Transmitted Light Metrology System; K. Roeth, et. Al.; 18th European Mask Conference, 2002; and Performance Data on the LMS IPRO2; K. Roeth; Leica) and provided to the mask user.

Characterize Reticle, ΔCD

Feature CD, (critical dimension or size) of structures is another critical aspect of photomask performance. Typical mask CDs for leading edge processes are <400 nm and the total variation budget allocated to all factors (i.e., mask, machine, process, etc.) is generally ≲±10%. For the mask to account for less than half of this (±5% or <±20 nm) means mask CD-SEMs have performance levels ˜±1-2 nm. So, in the course of mask inspection, the measured mask CDs after being recorded, can be provided to the mask user for incorporation in to a virtual reticle file.

Characterize Reticle, Phase, Transmission Errors

With the advent of attenuated phase shift masks (see The Attenuated Phase Shift Mask; B. Lin) that have partially transmitting (˜6%) and relative phase shifted regions (180° shift) there is a need to verify both the absolute value and variation across the mask of the transmission (T) and phase (φ). When measured and recorded in the course of mask quality control, they can be provided to the user for incorporation into virtual reticle files.

Characterize Reticle, Mask Clips (1d and 2d)

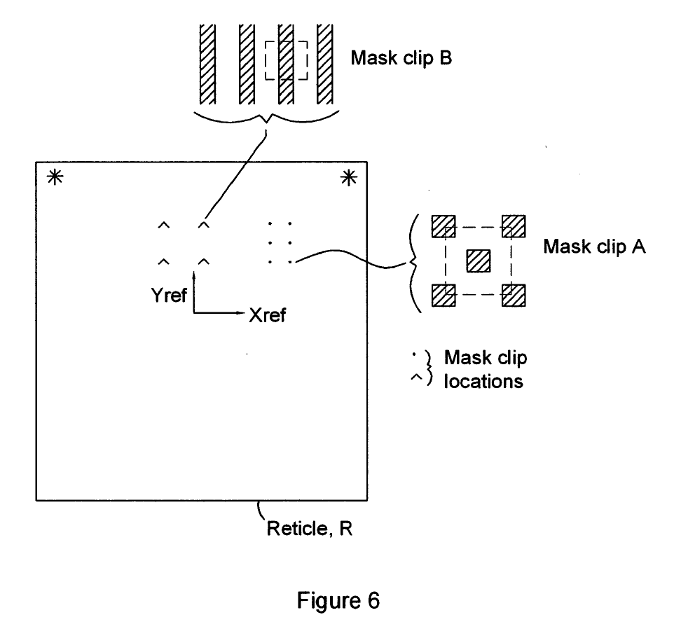

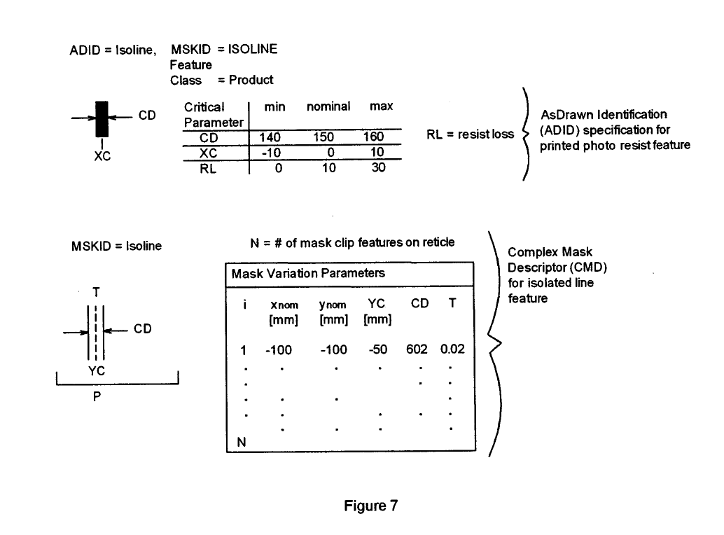

Methods for characterizing the mask (reticle) resist involve the collection of metrology data and the construction of mask clips (derived from GDSII files) representing all the features for emulation. In general, the GDSII file is usually the most complete detailed specification for the reticle generally available, but it is not directly suitable for detailed calculations of imaging performance (involving the preferred VME). Therefore, it must first be reduced to a series of small (≲2×2 um² in 2-dimensions, ≲5 um in 1-dimension) periodic ‘mask clips’ that are located at numerous discrete spatial sites across the image field (FIG. 6). The density of the mask clip sites should be less than, or equal to, about 50% of the shortest correlation distance, but a given mask clip should only be placed at or close to its actual occurrence on the reticle. Variation of mask clip geometry from site to site are allowed to occur. This is illustrated in FIG. 7 where the isolated line feature (with associated clip number) has a width (CD), a positional error (XC), a transmission (T), and a phase (P) that vary with site position (Xₙₒₘ, Yₙₒₘ). Either direct measurement of all relevant mask parameters or sampled measurements can form the basis for these inputs.

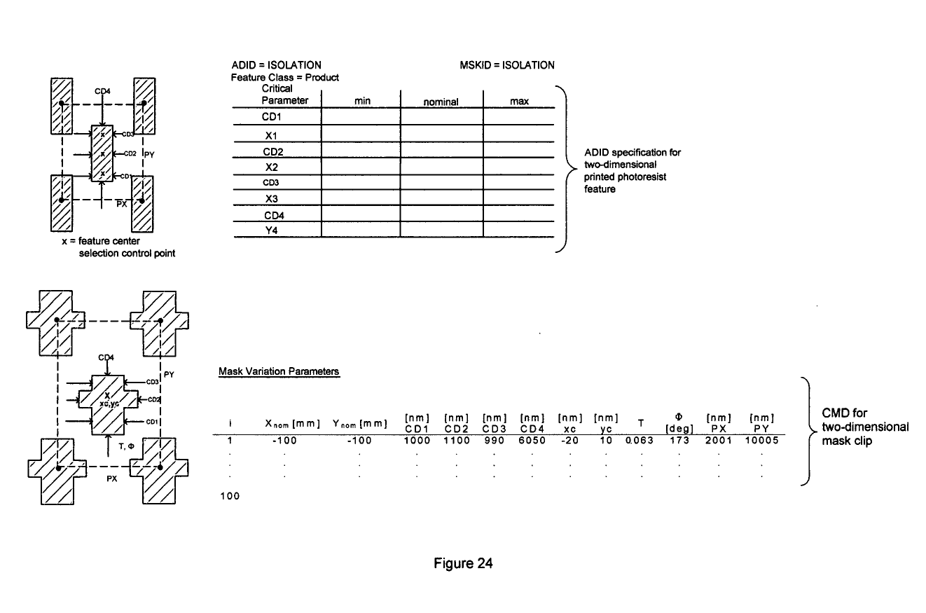

FIG. 24 shows an AsDrawn specification (ADID) for a 2-D printed photoresist feature (isolated)—where ADID=Isolation, with a 2-D array of critical parameters, and a sample of a 2-D complex mask descriptor (CMD) that details parametric variation in the mask clip across the reticle (including CD, phase, transmission, and position).

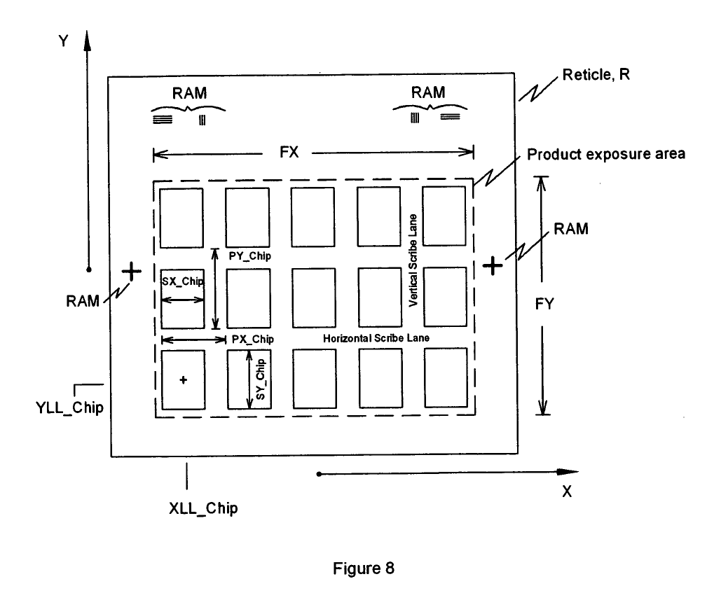

The entire reticle (for any particular process) is rather complex and can include many different circuits, chips, reticle alignment marks (RAM), wafer alignment marks (WAM), test structures, and metrology structures (see FIG. 8 for example). For complex mask analysis where 3-d effects are important (as compared with thin-mask approximations) the mask clips will contain a 3-d description of the transmission, phase, and position of all relevant mask features. This is important for rigorous descriptions of the light field with the mask (see T. Pistor, “Rigorous 3D Simulation of Phase Defects in Alternating Phase-Shifting Masks”, Panoramic Technology, Inc.).

Characterize Reticle, AsDrawn

The AsDrawn pattern may be characterized. For example, the specification for the ideal printed features as would be drawn by the device designer (AsDrawn specifications) can be used for comparison with machine emulation outputs. For VME operation the “AsDrawn” specification may be linked to the mask cell used to create it (FIG. 7) and also include limits on critical parameters (e.g., CD, shift, resist loss, etc.) beyond which the device is assumed to fail. This information, the ‘AsDrawn’ specification and parameterized mask clips may be entered into a virtual reticle library (VR_LIB) for future reference.

Characterize Reticle, Mask Sites

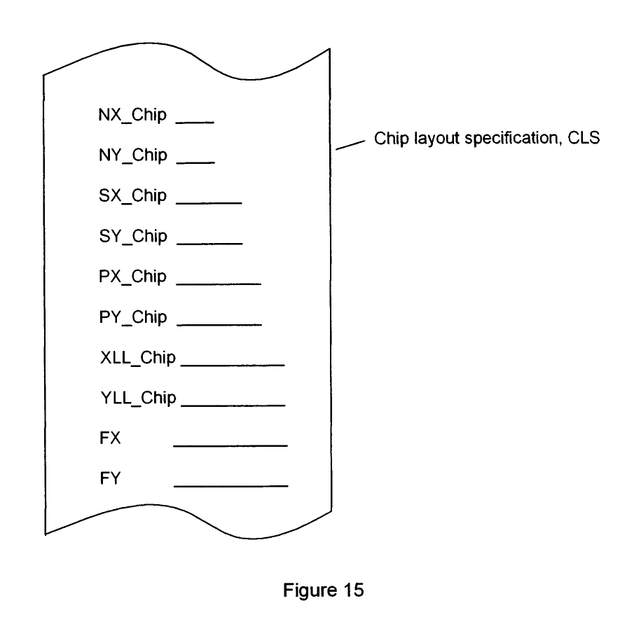

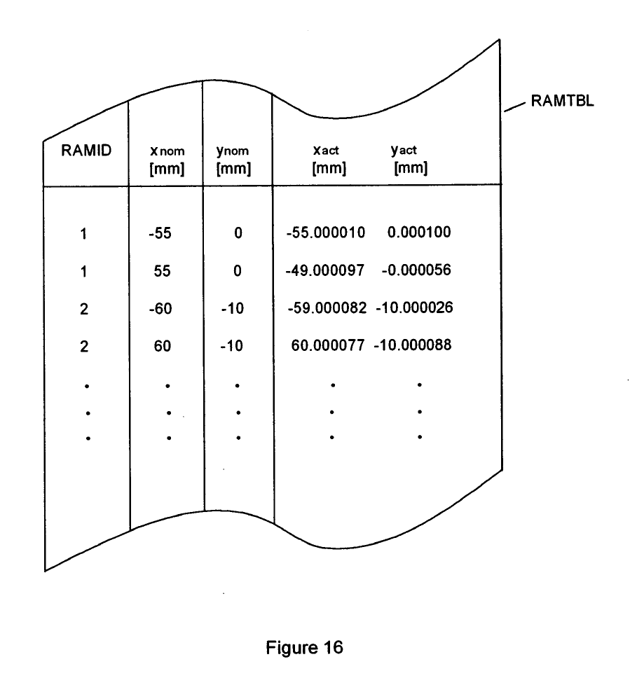

By mask sites, we mean the location of particular feature classes or feature groups. Thus, product features reside on discrete chips (FIG. 8) whose size and location on the reticle is characterized in the chip layout specification (CLS, FIG. 15). Reticle alignment mark locations, both actual and measured, are integral to chip layer to chip layer overlay. They are provided (FIG. 16, RAMTBL) so the transverse reticle alignment process can be more accurately modeled. Other special mask sites are the locations of wafer alignment marks. Those are used by the succeeding layer for transverse alignment and are important inputs to the TMOS module (FIG. 3).

Characterize Process/Layers

The process/layer may be characterized. For example, exact details of the actual lithography exposure process such as machine model (MM), machine setting ID's (for both the exposure tool and wafer track), field exposure sequence (FES), wafer notch angle orientation, process layer specific exposure conditions (focus and exposure), and exposure date (XPOD) can be used for reference and input into the VME—FIG. 2 reference 204. The designation for process/layer information as described is P/L.

Provide Virtual Wafer (VW), General

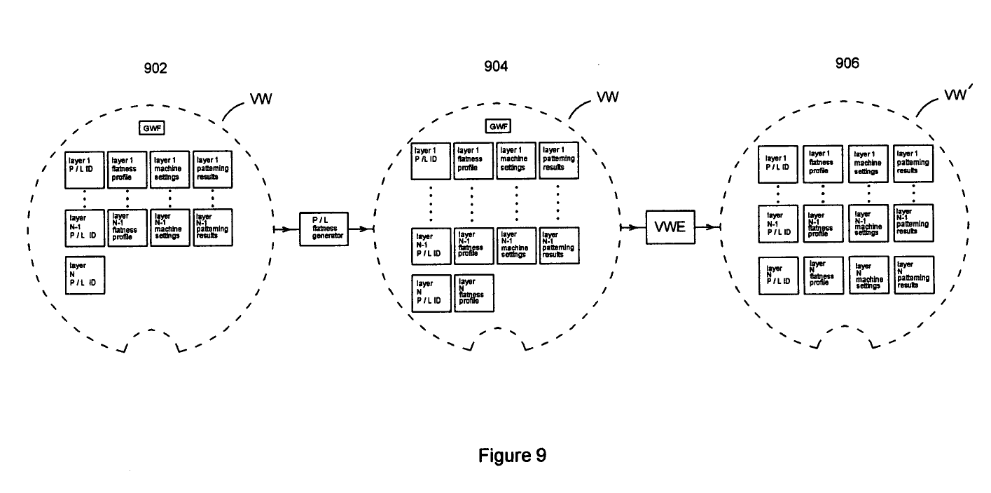

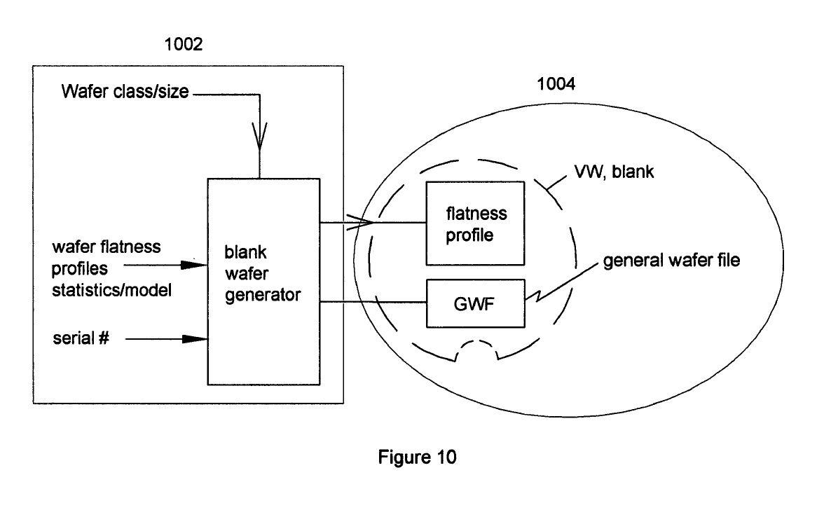

Finally, the V-ME requires a virtual wafer(s) (VW) for storing lithographic patterning results; where the VW is completely characterized prior to each lithographic processing step as shown in FIG. 9 references 902, 904 and 906. Characterized means that each VW can be represented by a general wafer file (GWF) that can include, for example, the wafer serial number, notch angle, wafer size, layer specific patterning results, layer specific machine settings, process layer IDs, and flatness profiles. Virtual wafer processing is shown in FIG. 9 where VWs move through the VME step-by-step (see FIG. 2 reference 204). For example, at the beginning of wafer processing a VW is created using a blank wafer generator (FIG. 10 references 1002 and 1004) that creates a GWF and initial wafer flatness profile. An initial flatness profile may be determined by statistical models and fab metrology data using a process layer flatness generator (P/L generator see FIG. 9 reference 902). At this point, the blank VW is ready for processing through the VME as shown in FIG. 9 reference 904. FIG. 2 references 216 and 218 show the process of updating or processing a VW where lithographic simulation output is combined with the original VW GWF using a virtual wafer bundler. The number of passes through the VME depends uniquely on the wafer processes being emulated. For most lithographic processes the number of passes might be on the order of 35 patterning steps. Also, it is important to note that while there may be 35 lithographic steps, the overall wafer process might make use of 100 or more processing steps which include depositions, etch, and a variety of others (see A. Landzberg, “Microelectronics Manufacturing Diagnostics Handbook”, pp. 63-64). The simulation engine described in the present invention has so far been concerned with lithographic patterning. It should be noted however, the VME can be made more general by simply extending the simulation capability to include etch processing, deposition, and implant as described below.

It is noted that the order for performing machine characterization has so far followed the process described in FIG. 1. It should be noted that in practice (during VME operation) the order for performing machine characterization may be determined by many factors (characterization time Ĉxᵢ, wafer processing, and application).

Block 2 (Virtual Library, X_LIB Detail)

As described in each step above (Block 1 in FIG. 1) the results for the methods of characterizing the lithographic machine and process may be entered into one or more libraries as shown in FIG. 1 Block 2. For example, in FIG. 2 there are three libraries illustrated, a machine library, a virtual reticle library, and a process/layer library. The overall structure for the VME is shown in FIG. 2 where each library module is accessed and updated through the use of an executive software module (FIG. 2 reference 206). The machine library (MA_LIB), virtual reticle library (VR_LIB), process/layer library (P/L_LIB) provide inputs into both the TMOS, ZMOS, and lithography simulator as shown in FIG. 2. The structure for each library will now be described.

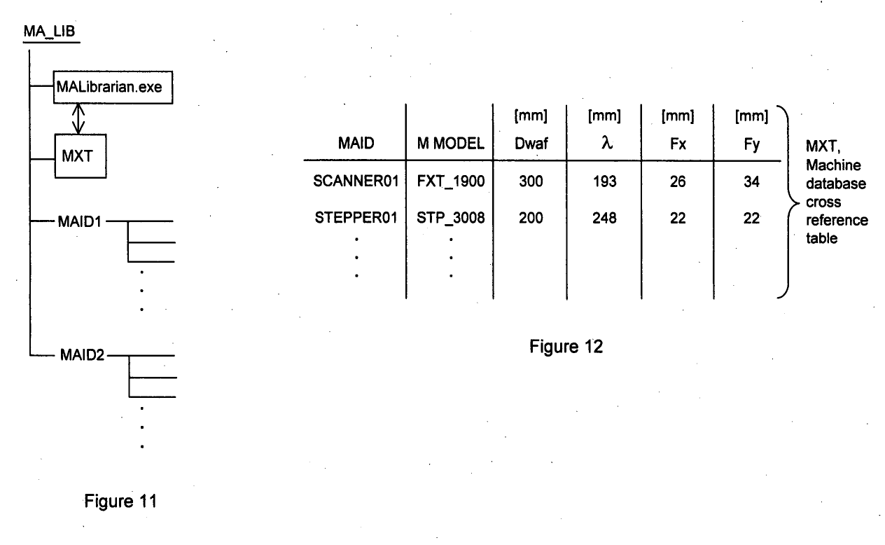

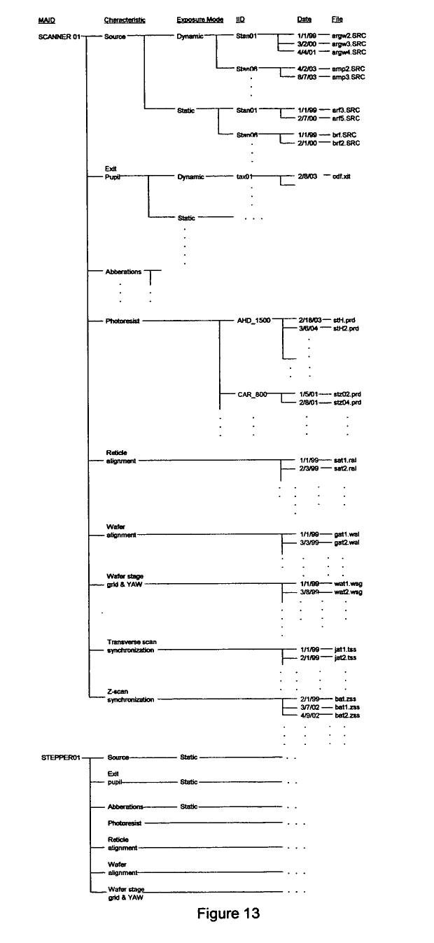

The machine library, for example (MA_LIB), can be thought of as a database storage facility with an active retrieval system as shown in FIG. 11. Here the hierarchy for the management of the machine parameter database (the database that holds machine specific information) is shown to contain an executable program (MALibrarian.exe) to rapidly cross-reference high-level machine properties that are stored in a machine database cross-reference table (MXT FIG. 12). The list of parameters stored in the machine library stem from the outputs for preferred methods of lithographic characterization as described earlier. High level machine properties such as machine identification (MAID), machine model (M Model), wafer diameter(s) (Dwaf), wavelength (lambda), maximum field sizes (Fx, Fy) are stored in the MXT. The hierarchical layout of the entire machine database could take the form of the directory structure shown in FIG. 13. The entire MA_LIB is shown integrated to the VME in FIG. 2 reference 210 where the data can be accessed for specific emulation functions using the execution manager (FIG. 2 reference 206). For example, the transverse mechanical offset synthesizer (TMOS) produces scan specific mechanical transverse offsets (FIG. 3) using: library stored transverse scan synchronization parameters, reticle alignment mark positions, wafer stage grid and yaw, and wafer alignment mark locations (see FIG. 2 references 210 and 214). In a similar way, the Z-mechanical offset synthesizer module (ZMOS, FIG. 4) generates site-by-site wafer flatness (including synchronization and leveling error) by accessing z-mode information from the MA_LIB as shown in FIG. 2 references 210 and 212.

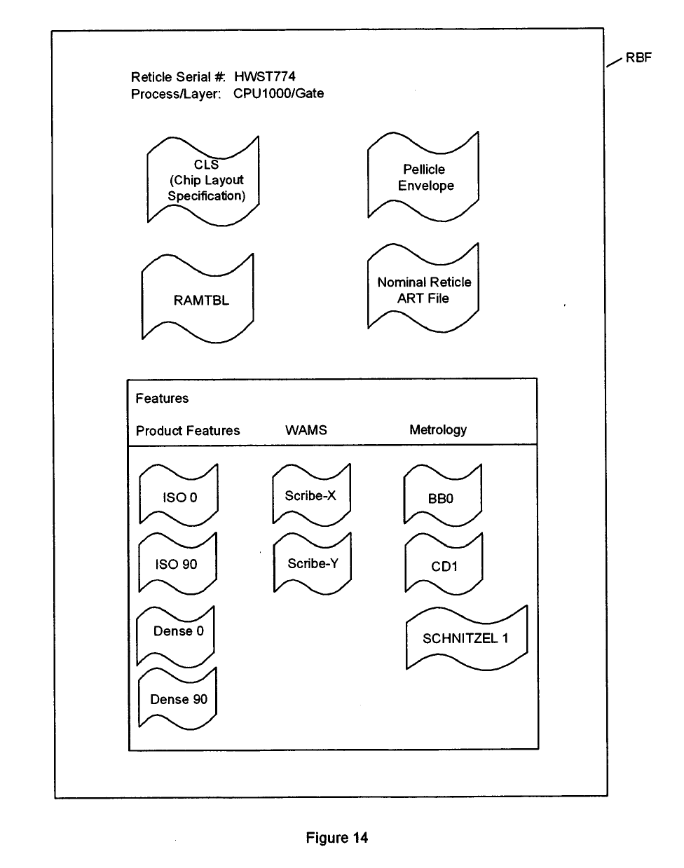

The virtual reticle library (VR_LIB) stores and organizes information (for example, see reticle characterization) pertaining to virtual reticles (VR). Each virtual reticle corresponds to a unique physical reticle with a unique reticle serial number and process layer (see FIG. 14). For emulation, a virtual reticle can be identified with a unique reticle bundle file (RBF) that contains all the information (data) for the physical reticle (see FIG. 14) including: chip layout specifications (CLS FIGS. 15 and 8), reticle alignment mark tables (RAMTBL FIG. 16), pellicle information, nominal reticle data, feature specific information (product features, wafer alignment marks (WAMs), and metrology features), in a form or subset suitable for emulation using the VME and execution manager (see FIG. 2 reference 208). For example, detailed metrology features (box-in-box targets, psm targets, and wafer alignment marks) might appear in the RBF. Other instances of feature class=metrology include: scatterometry targets, electrical CD targets, and wafer alignment marks.

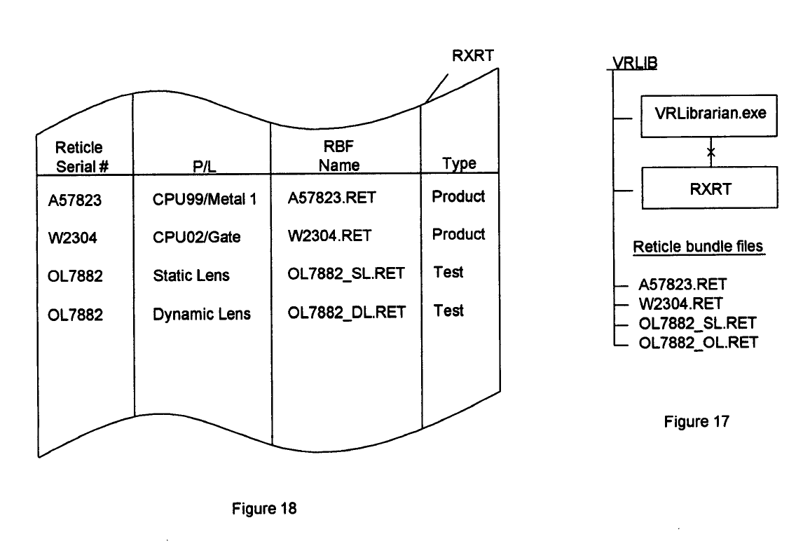

On a higher level, the virtual reticle library holds virtual reticles composed of mask clip files, AsDrawn (1d and 2d) specification files, and critical mask (or simulation sites), and mask specific information (transmission, material, phase, distortion, CD metrology) as described in methods for characterizing the reticle. The hierarchy structure for the virtual reticle library is similar to the hierarchy described for the machine library. For example, in FIG. 17 an executable program (VRLibraian.exe) can be used to rapidly identify a virtual reticle for emulation using the cross-reference table (RXRT) shown in FIG. 18. The execution or extraction of information from a virtual reticle into the image and resist development simulator is shown in FIG. 2 references 208 and 214 and is mediated by the execution manager of the VME (FIG. 2 reference 206).

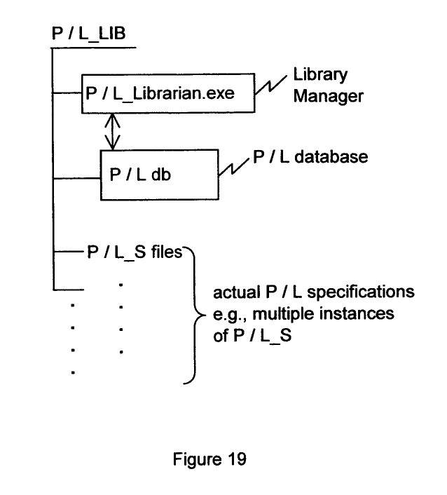

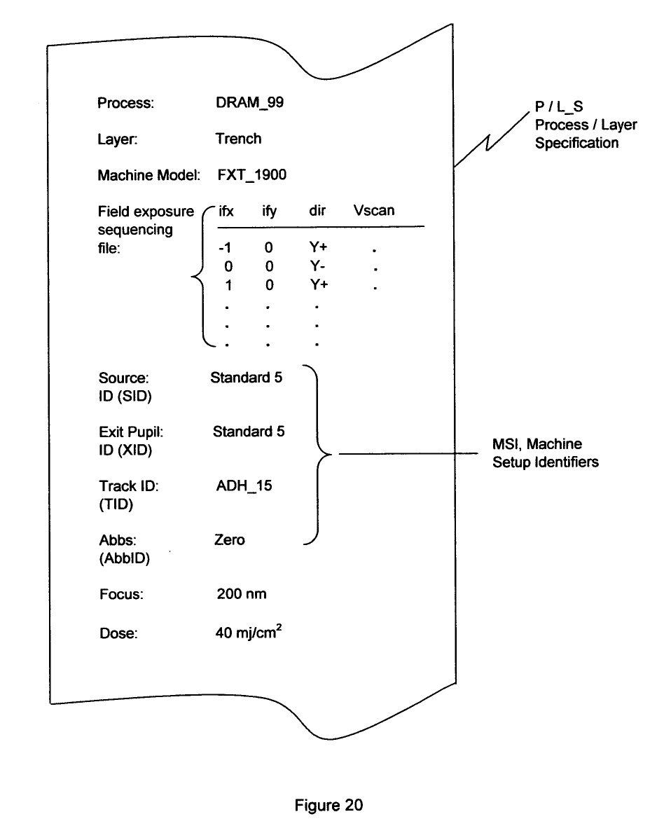

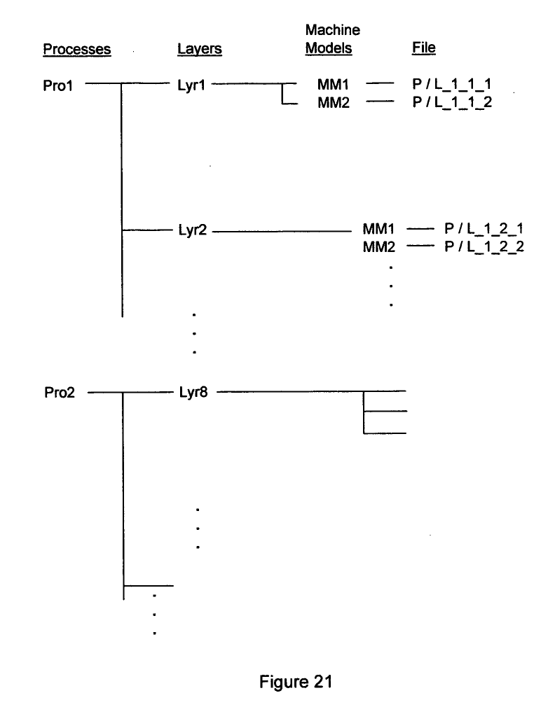

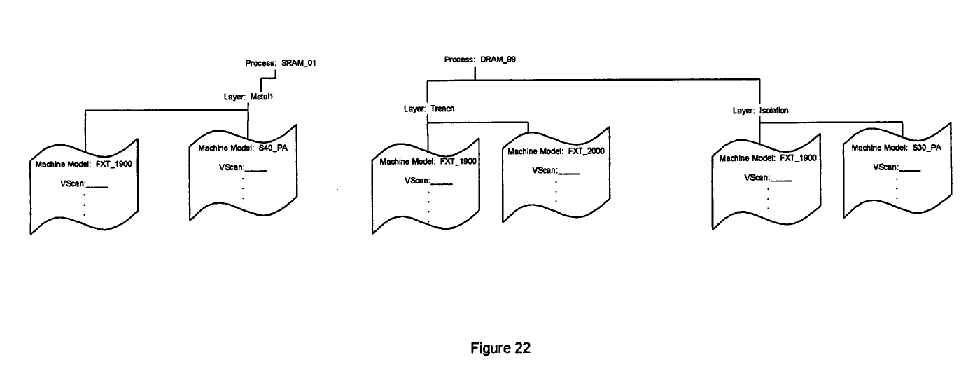

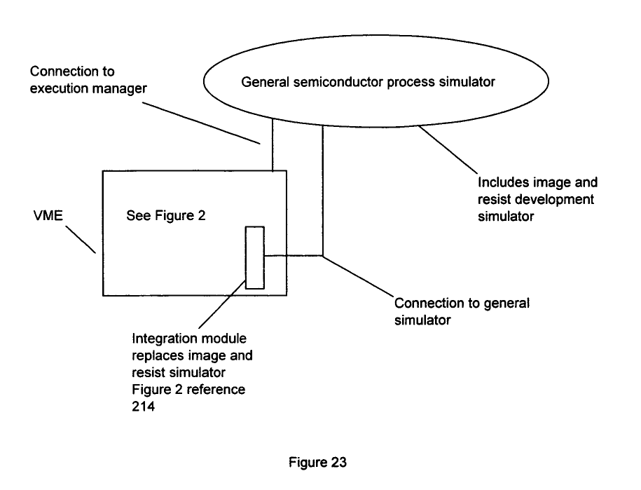

The process and layer library or P/L_LIB stores/organizes process specific information such as machine setting ID's, field exposure sequencing using a library management program. The hierarchy for the management of process layer specification is shown in FIG. 19 where again, a library manager (P/L Librarian.exe) is used to quickly access a process layer database. The process and layer library also contains process layer specification files (P/L_S) that contain detailed field exposure sequencing information and machine setup identifiers (MSI) for a unique process (see FIG. 20). The machine setup identifiers include: source, exit pupil, track, aberrations, focus, and dose information unique to machine and process/layer. A hierarchical layout (in terms of a database or directory structure) of process and layer specifications for organized machine emulation over a range of machines models and processes is shown in FIGS. 21 and 22.

As described in methods for providing a virtual wafer (VW), a general wafer file (of GWF) or wafer bundle file is used to store virtual wafer patterning information (see FIG. 2 references 202, 204, and 206). The GWF and its associated VW represents a unique physical wafer with a unique product id. Patterning information includes: process and layer ids, flatness profiles—for each layer or process, machine settings, and patterning results.

Block 3 (Machine Simulator Detail)

The actualization of the emulation for processing virtual wafers using the VME (FIG. 2) depends on the configuration and operation of the lithographic simulator (FIG. 2 reference 214). For the present invention, the lithography simulation engine may be configured in such a way as to accept the input, most of which is derived from methods for characterizing the projection machine, reticle, and process layer. For example, the simulation engine may be configured to accept side by side wafer flatness and z-synchronization error (ZMOS output), source description, exit pupil transmission function, lens aberrations, resist description, scan by scan mechanical transverse error (TMOS output), focus settings, exposure settings, virtual mask or reticle, AsDrawn files, appropriate simulation sites, flare, and vibration data (see FIG. 2 reference 214). The VME execution manager controls the overall process (processing virtual wafers thru the simulator) as shown in FIG. 2 reference 206. Simulation output (FIG. 2 reference 218)—which depends on the actual process being emulated (experiment or production runs for example) and the simulation engine—includes: CD, deltaCD, feature position, side wall angle, resist loss, aerial image, process window analysis, overlay analysis—layer-to-layer positioning, yield analysis, error analysis, exposure latitude, depth of focus, and several lithographic and factory metrics—including thru-put (see “A Comprehensive Guide to Optical Lithography Simulation”, supra). So far, the VME simulation engine for the preferred embodiment takes the role as a lithography simulator. It should be mentioned that the simulator could also be configured to perform simulation relating to depositions, thermal treatments, etch, ion-implant and other semiconductor fab processes. Methods for characterizing these processes can be found in several references (see “Process Simulation Paper General (Etch, Ion-Implant) Virtual Wafer Fab (Integrated TCAD Environment)”, supra).

Inputs to the VME (FIG. 2, Block 204) are typically just the exposure data, reticle serial number, machine identifier (MAID) and a virtual wafer, VW. Process/layer information (P/L) would be additionally provided only to override the P/L inherent in the VW; this might be used for diagnostics. Also focus (F) and dose might be manually set to override the values inherent in the P/L information contained in the VW.

Inputs (204) then flow into an interface or input module that parcels out the input information into an internal (within block 202) process/layer specification, locations (preferably actual locations) of wafer alignment marks (WAM), a wafer flatness profile (usually a combination of a statistical model with prior layer processing information and a model of the wafer chuck clamping mechanism), mask and AsDrawn clips of manageable (≲2×2 μm²) size that reflect mask fabrication errors (‘characterize reticle, distortion, ΔCP, phase, transmission’ supra) and diverse locations on the reticle, and reticle alignment mark (RAM) locations among other things.

Next, and looking inside block 210, we look up the MAID in the machine library (MA-LIB) to get the machine model, MM. The process/layer library (P/L_LIB) is then queried with MM, P/L and the exposure data (XPOD) to yield the focus (F), dose (E) standard machine setting designators (SID, XID, AID, TID), and the sequence or order that the fields are exposed in as well as the scan speed (FES).

Next, and continuing from left to right in block 210, FES and the machine setting designators query the machine library (MA_LIB) and the detailed, machine and setting specific data we have measured or otherwise characterized (vide supra) is provided. This includes source and exit pupil profile, lens aberrations, resist development rate/model, reticle alignment mark models with machine specific parameters and offsets (RAM Model), a wafer alignment mark model with machine and process specific offsets and parameters (WAM model), for dynamically operated scanners transverse scan synchronization parameters (TSS parameters) and Z-scan parameters (i.e., scan induced piston and roll), and wafer stage grid and yaw model and parameters for characterizing the field to field wafer stage error. This information then flows into one or more of the TMOS module, ZMOS module, or the image and resist development simulator.

Continuing then to the right within block 210, some of the aforementioned information in addition to the WAM locations, field exposure sequence (FES), RAM locations and Vscan are fed into the transverse mechanical offset module (TMOS module) where individual field by field and scan synchronization transverse (X, Y or within the wafer plane) offsets are calculated. FIG. 3 shows in greater detail the individual processes going on within the TMOS module. A wafer alignment module (WAL module) uses the WAM model pulled in from MA_LIB along with WAM locations from the virtual wafer (VW) to effectively model the machine alignment process for the particular wafer; this includes a random contribution whose statistical magnitude comes from the WAM model. Typically, and this will depend on the specifics in the P/L settings, wafer translation (ΔX_{w},(ΔY_{w}), rotation (Y_{w}) scale (SX_{w}, SY_{w}), and field scale (ΔFₓ,(ΔF_{y}), are set by the WAL module.

Wafer grid and yaw are modeled by the WGY module which combines repeatable and non-repeatable error components of the field to field wafer stage error into an additional translation and rotation experienced at each exposure field. RAL module uses the machine specific RAM model and RAM locations (measured and nominal) extracted from the reticle bundle file (RBF) that describes the virtual reticle (VR) to assess the reticle translation (ΔXᵣ, (ΔYᵣ), rotation (Yᵣ), and scale (SXᵣ, SYᵣ).

In scanners, in addition to the above sources of transverse placement error, there will be a contribution from synchronization error between moving reticle stage and wafer stage that is modeled by the TSS module. Inputs to it are repeatable and non-repeatable components as a function of field position, scan direction and scan speed. Field sequencing (FES) and scan speed (vscan) inputs then select which TSS parameters are applied in the instant situation.

Outputs from these four modules (WAS, WGY, RAL, TSS) are then fed into a combination module that vectorally combines the outputs as a combined offset that varies form field to field and within each scan. These outputs then flow into block 214.

The next process that takes place (or it can be in parallel with the TMOS module calculations) is block 212 in FIG. 2. This is the Z-mechanical offset module (ZMOS module) that computes mechanical pitch, roll and defocus on a field by field (and in the case of scanners within the field) basis. FIG. 4 illustrates in more detail the inputs to the ZMOS module. The net Z-shift is the sum of contributions from various inputs. Wafer flatness specification comes from the virtual wafer (VW) and is combined with the wafer chuck model to get the as mounted wafer height profile. This profile is combined with a model of the machine focusing mechanism to arrive at the field by field wafer profile. In the case of scanners, additional piston and roll synchronization error during scan is accounted for using the ‘Z-scan synchronization model’ of FIG. 4. The upshot is we get effective focus on a site by site basis across the wafer that is input to block 214.

At this point, having computed the mechanical XYZ offset at each point on the wafer, we can run the image and resist development simulator, block 214, at the simulation sites specified in the VW. Focus value, F, is added along with focus values as determined by the ZMOS module to get the actual focus value. This is most efficiently accomplished by adding the focus value to the entire range of focus values determined in block 212 and then doing simulations within block 214 at regular intervals within this new focus range. To derive the CD or other value at the specific focus value required at a particular point on the wafer, we merely interpolate our result. Handling XY shifts from TMOS module is simpler; we simulate with 0 offset and then add the required offsets afterwards. What results from this process are CD and positional offsets (ACD and ΔX), resist loss, wall angles and other parameters, that are put into a standard report which is then bundled with the input virtual wafer, VW, to create the output virtual wafer, VW.

This updating process from VW to VW is shown in FIG. 9.

Block 4 & 5 (Create Updated VW Detail)

Following execution of the lithography simulator a virtual wafer bundler (VWB) updates the VW GWF with the current process layer results as described in the VW characterization section. Once the VW GWF is updated the VW can be processed again (see FIG. 9).

Confidence Level (Accuracy and Repeatability)

The preferred methods for characterizing the machine and lithographic process are of high enough confidence level that emulation is possible and reliable. For example, the repeatability for characterizing the source (eccentricity and ellipticity) as stated in “In-Situ Source Metrology Instrument and Method of Use”, supra is reported to be less than about 1% with an overall accuracy less than about 0.5% (see Litel Instruments ISI Product Brochure). The repeatability of characterizing the lens aberrations as stated “Apparatus, Method of Measurement and Method of Data Analysis for Correction of Optical System”, supra is reported to be approximately 1.4 mwaves with an overall accuracy less than about 0.2 mwaves. The accuracy and repeatability for the preferred method of determining exit pupil transmission is similar to that disclosed for source mapping since both techniques use similar reconstruction methods. The repeatability for the preferred method of determining machine mechanics is reported to be less than about 0.5 nm (see J. Bendik et al., “A Simulation Performance Framework Using In-Situ Metrology”, Optical Microlithography, Proc. SPIE, 2005).

While the preferred method for characterizing the resist and resist process (generating modeling parameters) is robust (see “A Parameter Extraction Framework for DUV Lithography Simulation”, supra) it is often difficult to ascertain the accuracy (and repeatability) of any set of resist simulation parameters for several reasons. First, most lithography simulators simulate a resist cross-section (2 dimensions) and then extract the following critical parameters: CD, SWA, resist loss, and feature shift. Most fabs however measure critical parameters using a CDSEM (or optical inspection tool) which is positioned above the resist feature patterns—there is not necessarily a one-to-one correspondence between these different metrology techniques. A method for cross-calibrating CDSEM data with the cross-section SEM is discussed in the work by Jones (see “Top Down Versus Cross Sectional SEM Metrology and its Impact on Lithography Simulation Calibration”, supra). For the present invention, a preferred method for measuring the complete resist profile (quite suitable for fabrication facilities) is described in the work by Bao (see J. Bao et al., “A Simulation Framework for Lithography Process Monitoring and Control Using Scatterometry”, ACE/APC XIII Symposium, 2001, pp. 1-4) where highly accurate, multi-wavelength scatterometry is used for metrology, simulation, and lithographic process control. Secondly, since many different metrology tests (DRM, FE matrix, ellipsometry, diffusion tests, chemistry tests, temperature plate measurements to name a few) are used to characterize one resist and one resist process the accuracy and repeatability of each technique needs to be reported. Additionally, even if the accuracy and repeatability for each resist metrology test were known, it is often difficult to ascertain the impact to the simulation output since the parameters are often cross-coupled (depending on the models used). This is not to say it is impossible to produce a set of accurate simulation parameters. The methods discussed in Jakatdar (see “A Parameter Extraction Framework for DUV Lithography Simulation”, supra) are sufficient since a feedback system is used to tune the overall modeling parameters so that simulation results match fab measurements (including scatterometry measurements) with sufficient (and practical) accuracy.

Finally, as noted earlier, the VME characterization libraries must be updated on a regular basis to reflect changes in the machine and process states. Only by insuring that the VME is supplied with the most accurate and repeatable characterization data are the following critical risk/reward applications economically and practically viable: machine adjustment, machine specific product flow, lot disposition, lot rework, process development, and advanced process control. In fact, once the VME is up running it can serve as a flag to note process changes if the emulation results are different from fab measurement results.

### Alternate Embodiments

A number of variations of the preferred embodiment are possible and now described in some detail.

Integrated Emulation (First Variation)

The method of construction for the VME (see FIG. 2) can be changed to reflect integration of the VME into an APC architecture. An APC architecture is described in “Advanced Process Control for Semiconductor Manufacturing”, supra, where the application interface allows for the integration of the VME and lithography engine into a factory control system (see col. 7 lines 15-18 for example). Here the emulation engine would operate at the discretion of the overall fab supervisory control system. By operation we mean the VME could be running continuously—mimicking many different machines and processes. The output from the VME could be used by the APC supervisory system to insure proper product routing, find better machine matches (overlay control), offer control strategies, flag machine and process errors (real-time failure analysis) and several other applications as described below. In order to insure proper emulation the VME must be continuously updated with new information related to changes in the machine and process state. In a sense, therefore the VME operates in two states (emulation mode, simulator mode) depending on the stability of the machine and process.

VME Tuning (Second Variation)

During set-up (before VME operation) the VME can be tuned for better performance by linking the VME into an APC framework or feedback framework such as those described in see “Advanced Process Control for Semiconductor Manufacturing”, supra, and “A Parameter Extraction Framework for DUV Lithography Simulation”, supra (see FIG. 5). This works by adjusting the internal models and parameters of the simulation engine in such a way to match the actual lithographic metrology (CD, SWA, Position, and Resist Loss) derived from production or experimental runs.

More General Emulation and Integration into a General Simulator (Third Variation)

As described earlier, the VME may be configured with a lithography simulator (FIG. 2 reference 214) that accepts input derived from preferred methods for characterizing the lithographic machine and process. It is possible that a more general semiconductor process simulator can be substituted for the lithography simulator if the more general simulator contains a lithography simulation module and is configured properly. FIG. 23 shows one possible VME configuration where a very general semiconductor process simulator (a general process simulator can simulate lithography, etch, ion-implant, deposition, etc.,) contains a lithography simulator capable of operating in a manner consistent with the preferred embodiment. The purpose of including a more general semiconductor process simulator is that (at some time) it might be possible to emulate an etch process or deposition process with the accuracy described in the preferred embodiment. This way, eventually the emulator will take on the appearance of a virtual semiconductor emulator or VSE.

Factory and CoO Emulation (Fourth Variation)

So far the VME engine has been described as a lithographic emulator or more general process emulator. The integration of the VME into a factory simulator for business applications such as cost of ownership (CoO) or more general return on investment decisions is also possible since semiconductor businesses are costly operations and the lithographic process is the most expensive. For example, the VME can be used to decide if a new set of lithographic projection imaging tools would improve yields and be economically viable as compared with upgrading older tools (new laser or new stages for example) or finding a better machine to machine product flow (improving overlay). This can be realized by running the VME with other business software and predicting lithographic yields based on the input. Additionally, the VME described in the present invention could be configured to supply some of the necessary inputs for business applications such as: thru-put, yield, routing, and go-no-go metrics.

Example Applications

The VME is of high enough reliability to warrant the following difficult applications (virtually). The ability to perform the following applications—virtually—is extremely useful since the cost for each operation (application) is very expensive.

Machine adjustment: changes in machine performance (source, lens, exit pupil, and mechanics) reflected by VME output can be fed back to an APC factory controller or fab maintenance queue for rapid (or real-time) machine adjustment (similar to methods disclosed in Nikon Corp., “Method of Forming and Adjusting Optical System and Exposure Apparatus, and for Determining Specification Thereof and Related Computer System”, European Patent No. EP 1231516 A2, 2002, or “Advanced Process Control for Semiconductor Manufacturing”, supra.

Machine specific product flow: since the VME can be configured for running many machines and processes simultaneously, the VME can be linked to an optimizing engine to find the optimum (highest yielding or best performance binning) lithographic machine to machine process flow. For example, since each projection machine has slightly different overlay characteristics (mechanics) the VME can be used to find the set of machines that will give the best overall overlay performance—on a continuous basis (see M. Dusa et al., “Comprehensive Focus-Overlay Correlation to Identify Photolithographic Performance”, Optical Microlithography, Proc. SPIE, Vol. 2726, 1996, pp. 545-554).

Lot disposition and lot rework: the ability of the VME to predict lithographic performance such as process yield, metrology (CD, and overlay) makes it an important tool for lot disposition. Consider for example a critical research wafer lot reaching a certain metal contact layer (DRAM processing) where miss processing might give a competitor an advantage. If the VME is run prior to the lot reaching the machine and process in question (maybe a day or more ahead of the wafer) the VME can identify a potential yield problem (CD and overlay error) and route the lot to a machine with the correct machine characteristics for proper processing. If time is not so critical, the VME could be used to decide if the lot should be reworked—depending on the critical (or desired) yield requirements.

Process development: since output from the VME simulation engine includes metrology data (CD and overlay information) the VME can be used to design lithographic processes with exceptionally high yield in a very short period of time. This is actualized by integrating the VME output (metrology or patterning data) to an optimizer such as those methods described in Jakatdar (“A Parameter Extraction Framework for DUV Lithography Simulation”, supra) and running until convergence—where the VME output and the desired lithographic metrics (critical parameters) agree.

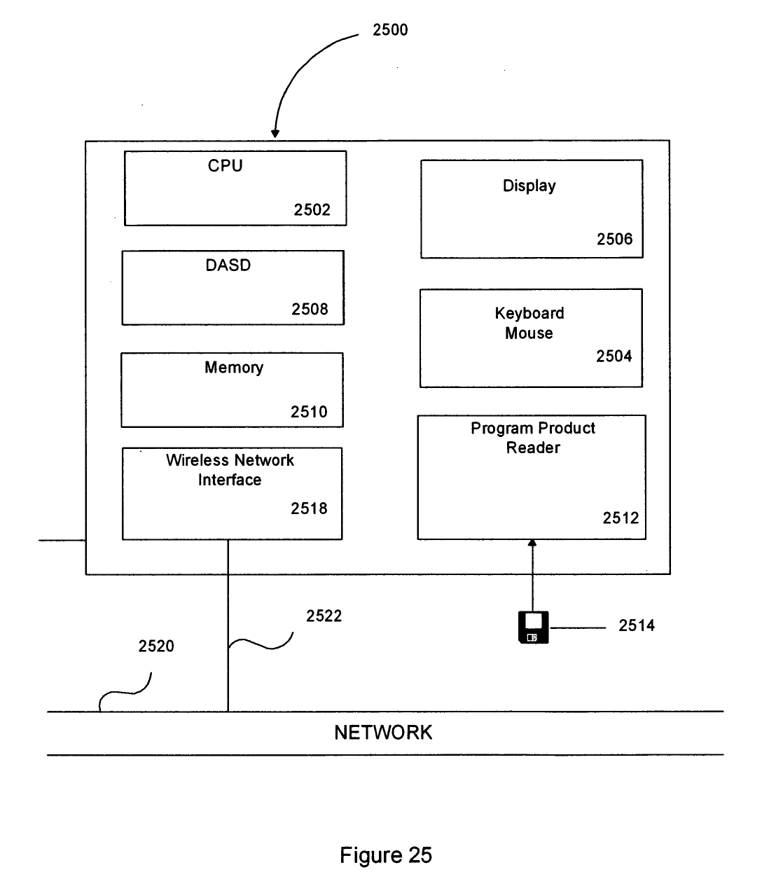

FIG. 25 shows an exemplary computer 2500 for executing the operations described above. The computer 2500 may operate in a networked environment that permits communication with other computers. The computer 2500 operates under control of a central processor unit (CPU) 2502, such as a “Pentium” microprocessor and associated integrated circuit chips, available from Intel Corporation of Santa Clara, Calif., USA. A computer user can input commands and data from a keyboard and computer mouse 2504, and can view inputs and computer output at a display 2506. The display 2506 is typically a video monitor or flat panel display. The computer 2500 also typically includes a direct access storage device (DASD) 2508, such as a hard disk drive. A memory 2510 typically comprises volatile semiconductor random access memory (RAM). Each computer 2500 preferably includes a program product reader 2512 that accepts a program product storage device 2514, from which the program product reader 2512 can read data (and to which it can optionally write data). The program product reader can comprise, for example, a disk drive, and the program product storage device 2514 can comprise removable storage media such as a magnetic floppy disk, a CD-R disc, a CD-RW disc, or DVD disc.

The computer 2500 can communicate with any other computers, if networked, over a computer network 2520 (such as the Internet or an intranet, or a wireless communication channel) through a network interface 2518 that enables communication over a connection 2522 between the network 2520 and the computer. The network interface 2518 typically comprises, for example, a Network Interface Card (NIC) or a modem that permits communications over a variety of networks, or a wireless modem.

The CPU 2502 operates under control of programming instructions that are temporarily stored in the memory 2510 of the computer 2500. When the programming instructions are executed, the computer 2500 performs its functions. Thus, the programming implements the functionality of the system described above. The programming steps can be received from the DASD 2508, through the program product storage device 2514, or through the network connection 2522. The program product storage drive 2512 can receive a program product 2514, read programming instructions recorded thereon, and transfer the programming steps into the memory 2510 for execution by the CPU 2502. As noted above, the program product storage device 2514 can comprise any one of multiple removable media having recorded computer-readable instructions, including magnetic floppy disks and CD-ROM storage discs. Other suitable program product storage devices 2514 can include magnetic tape and semiconductor memory chips. In this way, the processing steps necessary for operation in accordance with the invention can be embodied on a program product.

Alternatively, the program steps can be received into the operating memory 2510 over the network 2520. In the network method, the computer 2500 receives data including program steps into the memory 2510 through the network interface 2518 after network communication has been established over the network connection 2522 by well-known methods that will be understood by those skilled in the art without further explanation. The program steps are then executed by the CPU 2502 thereby comprising a computer process.

The present invention has been described above in terms of presently preferred embodiments so that an understanding of the present invention can be conveyed. There are, however, many configurations for determining exit pupil transmittance not specifically described herein but with which the present invention is applicable. The present invention should therefore not be seen as limited to the particular embodiments described herein, but rather, it should be understood that the present invention has wide applicability with respect to image projection systems. All modifications, variations, or equivalent arrangements and implementations that are within the scope of the attached claims should therefore be considered within the scope of the invention.

1. A computer method of simulating operation of a lithographic projection imaging machine, the method comprising:
determining characteristics of the imaging machine;
determining characteristics of a reticle used in the imaging machine;
determining characteristics of layer specific processes; and
producing an emulation of imaging machine operations on a virtual wafer using the characteristics of the imaging machine, reticle, and layer specific processes.

2. A method as defined in claim 1, wherein determining characteristics of the imaging machine comprises determining the characteristics of at least an exposure source, lens aberration, exit pupil, mechanics, vibration, calibration offsets, or resist.

3. A method as defined in claim 1, wherein determining characteristics of the reticle comprises determining characteristics of at least a distortion, critical dimension, phase transmission error, mask clips, as drawn specifications, or mask sites.

4. A method as defined in claim 1, wherein determining characteristics of layer specific processes comprises determining characteristics of at least the machine model, machine setting identification, and field exposure sequencing.

5. A method as defined in claim 1, further comprising a database that stores the determined characteristics.

6. A method as defined in claim 1, further comprising updating a virtual wafer database with results from the emulation.

7. A method as defined in claim 1, wherein the lithographic projection imaging machine is a stepper, or a scanner.

8. A method as defined in claim 1, wherein the virtual wafer comprises:
flatness profile information; and
a wafer identification number.

9. A method as defined in claim 8, wherein the virtual wafer further comprises:
wafer alignment marks;
process layer identification;
machine settings; and
patterning results.

10. A method as defined in claim 1, wherein determining the characteristics of imaging machine, reticle, and layer specific process are updated periodically based upon fabrication statistics, throughput, cost considerations, advanced process control, or neural networks.

11. A method as defined in claim 1, further comprising entering results of the emulation into an optimizer and determining optimum operating conditions related to the projection imaging machine.

12. A method as defined in claim 11, further comprising exposing a wafer using the optimized operating conditions.

13. A method of emulating a lithographic projection imaging machine, the method comprising:
characterizing an exposure source of the projection imaging machine;
characterizing a lens aberration of the projection imaging machine;
characterizing an exit pupil of the projection imaging machine;
characterizing mechanic of the projection imaging machine;
characterizing a resist exposed by the projection imaging machine;
characterizing a reticle used in the projection imaging machine;
characterizing layer specific processes of the projection imaging machine;
providing a virtual wafer;
running a simulation on the virtual wafer using the characterizations; and
updating a virtual wafer database with the results of the simulation.

14. A computer method of emulating operation of a lithographic projection imaging machine, the method comprising:
receiving characteristics of an imaging machine, of a reticle used in the imaging machine, and of layer specific process; and
simulating the imaging machine operations on a virtual wafer using the characteristics of the imaging machine, reticle, and layer specific processes, wherein the simulation responds dynamically to changes in the characteristics.

15. A program product comprising program code of machine readable media for causing a machine to perform operations of:
receiving characteristics of an imaging machine;
receiving characteristics of a reticle used in the imaging machine;
receiving characteristics of layer specific processes; and
producing an emulation of imaging machine operations on a virtual wafer using the characteristics of the imaging machine, reticle, and layer specific processes.

16. A program product as defined in claim 15, further comprising using results of the emulation to determine optimum operating conditions related to the imaging machine.

17. A program product as defined in claim 16, further comprising exposing a wafer using the optimized operating conditions.

18. A method for producing a photolithographic chip mask work from a lithographic projection machine and process, the method comprising:
designing a lithographic design-of-experiment (DOE);
emulating the DOE comprising determining characteristics of the imaging machine;
determining characteristics of a reticle used in the imaging machine;
determining characteristics of layer specific processes;
performing an emulation on a virtual wafer using the characteristics of the imaging machine, reticle, and layer specific processes;
entering results of the emulation into an optimizer and determining optimum operating conditions related to the projection machine and process; and
exposing a wafer using the optimized operating conditions.

19. A method as defined in claim 18, wherein the lithographic projection machine comprises a stepper, a one dimensional scanner, a two dimensional scanner, an EUV scanner, an EPL machine, or an image side immersion lens.

20. A method as defined in claim 18, wherein the wafer comprises a silicon wafer coated with resist, a resist coated flat panel, a resist coated circuit board, or electronic recording device.

21. A method as defined in claim 20, wherein the electronic recording device comprises a CCD or CMOS device.

22. A microelectronic chip production system comprising:
a production system controller configured to accept characteristics of a lithographic projection system, characteristics of a reticle used in the lithographic projection system, and characteristics of layer specific processes, and to perform an emulation on a virtual wafer using the characteristics of the lithographic projection system, reticle, and layer specific processes;
a scanning controller that controls a scanner of the lithographic projection imaging system; and
a process controller that adjusts the operation of the scanner in accordance with the outputs generated by the lithographic virtual machine emulator and production system controller.

23. A method of controlling a lithographic projection imaging machine comprising:
performing lithographic emulation comprising:
determining characteristics of the imaging machine;
determining characteristics of a reticle used in the imaging machine;
determining characteristics of layer specific processes;
performing a simulation on a virtual wafer using the characteristics of the imaging machine, reticle, and layer specific processes; and
adjusting the projection imaging system in accordance with the results of the emulation.

24. A method as defined in claim 23, wherein the projection imaging system is adjusted to minimize process variation.

25. A method as defined in claim 23, wherein the projection imaging system is adjusted to minimize yield loss, and machine error.

26. A method as defined in claim 23, wherein the projection imaging system is adjusted to minimize machine error.

27. A method of tuning a lithographic virtual machine emulator comprising:
emulating a lithographic machine and process using a lithography simulator;
providing a set of fabrication measured lithographic data;
comparing the emulated lithographic output with the set of fabrication measured lithographic data;
adjusting simulation models and parameters in accordance with the comparison to minimize a difference between the emulation lithographic output and the measured lithographic data; and
repeating emulating, comparing and adjusting until a desired convergence between the emulation lithographic output and the measured lithographic data is achieved.

28. A method as defined in claim 27, wherein the lithographic data comprises a critical dimension, a sidewall angle, resist loss, feature position, process windows, Bossung plots, DRM data, resist information, or resist stack cross section information.

29. A method of performing cost-of-ownership analysis comprising:
performing lithographic emulation of an imaging machine comprising:
determining characteristics of the imaging machine;
determining characteristics of a reticle used in the imaging machine;
determining characteristics of layer specific processes;
repeating performing lithographic emulation for a desired number of machines;
providing a cost-of-ownership analysis software; and
determining a cost-of-ownership using the analysis software.

30. A method as defined in claim 29, wherein the imaging machine comprises a stepper, a one dimensional scanner, a two dimensional scanner, an EUV scanner, an EPL machine, or an image side immersion lens.
